(19) United States
(12) Patent Application Publication
(10) Pub. No.: US 2026/0001654 A1
(43) Pub. Date: Jan. 1, 2026

(54) METHOD FOR CONTROLLING A HYBRID TURBINE ENGINE

(71) Applicant: SAFRAN ELECTRICAL & POWER, BLAGNAC CEDEX (FR)

(72) Inventors: Philippe DELBOSC, MOISSY-CRAMAYEL (FR); Benoît Lucien MICHAUD, MOISSY-CRAMAYEL (FR)

(21) Appl. No.: 18/880,627

(22) PCT Filed: Jun. 28, 2023
(86) PCT No.: PCT/FR2023/050981

§ 371 Date: Jan. 2, 2025

(30) Foreign Application Priority Data
Jul. 5, 2022 (FR) 2206865

(51) Int. Cl. B64D 31/18; B64D 27/33; B64D 45/04; H02J 7/34

(52) U.S. Cl. CPC B64D 31/18; B64D 27/33; B64D 45/04; H02J 7/345; B64D 2221/00; H02J 2207/50

(57) ABSTRACT

A method for controlling a hybrid turbine engine for an aircraft uses an energy storage assembly having a plurality of capacitive components. The turbine engine having a low-pressure shaft, a high-pressure shaft, and at least one power conversion device mounted on the low-pressure shaft or high-pressure shaft. The method includes precharging the capacitive components until a mean voltage reaches a first partial charge value, balancing the voltages of the capacitive components, charging the capacitive components until the mean voltage reaches a high value, and converting electrical energy stored in the storage assembly into mechanical energy delivered to the low-pressure shaft and/or to the high-pressure shaft in order to assist with maneuvering the aircraft.

### TECHNICAL FIELD OF THE INVENTION

The field of the invention is that of aeronautical turbine engines, and in particular that of aircraft engines produced in the form of twin-spool turbofans. More particularly, the invention relates to a method for controlling a hybrid turbine engine for an aircraft.

### PRIOR ART

Thermal/electric hybridization of an aircraft turbine engine provides a new path towards improving the behavior and performance of these turbine engines.

This hybridization consists of feeding or extracting mechanical power at certain times and at a certain level, through electric machines installed on the rotating shafts of the turbine engine.

A key requirement of conventional turbine engines for aircraft propulsion is to guarantee a maximum rise time that is not to be exceeded, between an idle speed where the engine only produces a low thrust and a maximum speed where the engine thrust is at its maximum.

A conventional twin-spool, turbofan type of turbine engine is schematically represented in FIG. 1.

It conventionally comprises, from upstream to downstream in the direction of the gas flow, a fan S, a low-pressure compressor 1, a high-pressure compressor 2, a combustion chamber 3 which receives a flow of fuel Qc, a high-pressure turbine 4, a low-pressure turbine 5, and a primary exhaust nozzle 6.

Low-pressure compressor 1 and low-pressure turbine 5 are connected by a low-pressure shaft 10, and together form a low-pressure body.

High-pressure compressor 2 and high-pressure turbine 4 are connected by a high-pressure shaft 9, and together with the combustion chamber form a high-pressure body.

Fan S, which is driven by low-pressure shaft 10 either directly or via a reduction gearbox, compresses coming the air from the air inlet. This air is divided, downstream of fan S, into a secondary air flow which is guided directly towards a secondary nozzle (not shown) through which it is ejected to contribute to the thrust provided by the turbine engine, and a so-called primary flow which enters the gas generator consisting of the low and high pressure bodies, then is ejected into primary nozzle 6.

Conventionally, it is known to install electric generators in the turbine engine in order to power the onboard electrical system. These generators are driven by high pressure shaft 9 via an accessory gearbox, in order to convert the mechanical energy into electrical energy intended for the secondary systems on board the aircraft.

One variant may consist of replacing at least one of the electric generators with at least one starter for starting up the turbine engine using electrical energy. Startup is achieved by controlling the electric starter via a converter located either in the engine zone or in the cockpit zone, powered by a source external to the turbine engine to be started. This source may be either a ground-based power unit or another onboard electrical source that has been previously activated (auxiliary power generator, electrical generator of other turbine engines). Once the turbine engine has started up, the electric starter changes mode to operate exclusively as an electrical generator.

However, the use of such a system to assist the turbine engine by supplying a significant amount of electrical energy is not always satisfactory, because it requires the use of a high-capacity electrical energy source located within the aircraft zone as well as associated electrical connections, which generates significant bulk and high electrical losses.

### PRESENTATION OF THE INVENTION

The invention aims to overcome these disadvantages by providing a method for supplying energy to the turbine engine which allows rapid delivery of a large amount of electrical energy, while ensuring good stability and durability of the system.

For this purpose, the invention relates to a method for controlling a hybrid turbine engine for an aircraft, the turbine engine comprising a low-pressure body having a low-pressure shaft and a high-pressure body having a high-pressure shaft, the turbine engine also comprising at least one power conversion device mounted on the low-pressure shaft or high-pressure shaft and an energy storage assembly connected to the power conversion device, the energy storage assembly comprising a plurality of capacitive components, the method comprising steps of:
precharging the capacitive components until a mean voltage across the capacitive components reaches a first partial charge value,
balancing the voltages across each of the capacitive components,
rapidly charging the capacitive components until the mean voltage across the capacitive components reaches a high value, and
converting electrical energy stored in the storage assembly into mechanical energy delivered to the low-pressure shaft and/or to the high-pressure shaft in order to assist with a maneuver of the aircraft.

Such a method allows optimizing the operation of the capacitive components, by using the maximum amount of stored energy without degrading their service life.

Indeed, wear in the capacitive components is mainly linked to temperature, which in our case depends on the environment and is difficult to control, and the voltage maintained at the terminals of the capacitive components. In order to take the most advantage of their energy for assisting the turbine engine, the capacitive components are charged up to their maximum voltage value (typically 2.85V) just before the flight stage that requires assistance.

The first partial charge value and the second partial charge value are chosen so that the capacitive components can be maintained at such voltage values without accelerated aging or appreciable damage.

The high voltage value is substantially equal to a maximum charge voltage of the capacitive components.

The precharge step may be implemented when the aircraft is stationary on the ground.

The balancing step may be implemented when the aircraft is traveling on the ground to a takeoff location.

The rapid charging step may be implemented during an aircraft stop for pre-takeoff checks.

The aircraft maneuver may be a takeoff.

Alternatively, the maneuver may correspond to any other flight phase requiring acceleration of the turbine engine shafts or a rapid increase in speed of the turbine engine shafts.

Such a feature makes it possible to provide additional energy to the aircraft's propulsion at the most critical moment of the aircraft's acceleration.

The method may also comprise a step of using the electrical energy stored in the capacitive components to power loads of the aircraft during flight.

Such a feature makes it possible to improve the operation of the secondary circuits of the machine during a flight phase where assistance to the turbine engines is not required.

The power conversion device may be mounted on the high-pressure shaft and be arranged to transfer power only between the high-pressure shaft and the energy storage assembly, the turbine engine also comprising a second power conversion device mounted on the low-pressure shaft and arranged to draw power from the low-pressure shaft so as to power loads of the aircraft during flight.

Such a feature allows reducing the weight and cost of the power conversion device associated with the high-pressure shaft, it being responsible only for the load of the energy storage assembly.

This powering by the low-pressure shaft is compatible with improving the quality of the electrical network by means of the energy stored in the capacitive components.

The method may also comprise steps of:
recharging the capacitive components until the mean voltage across the capacitive components reaches a second partial charge value,
charging the capacitive components until the mean voltage across the capacitive components reaches the high value, and
making available the electrical energy stored in the capacitive components, during a second maneuver of the aircraft, in order to assist with a possible auxiliary maneuver, and
if the auxiliary maneuver was not implemented, discharging the capacitive components.

Such a feature makes it possible to assist with a possible auxiliary maneuver in which there is a need for acceleration assistance.

The second maneuver of the aircraft may be a landing and the auxiliary maneuver may be an emergency takeoff (touch-and-go, go-around, etc.).

Such a feature makes it possible to assist with an emergency maneuver when landing the aircraft, thus improving the safety of the landing.

The energy storage assembly may be configured to deliver a power greater than or equal to 500 KW for a duration of between 0.5 seconds and 2 seconds.

Such a feature makes it possible to concentrate the auxiliary power at a critical moment in the takeoff phase, for example.

The balancing step may be implemented by means of a balancing circuit configured to lower the voltage across each capacitive component to a threshold voltage after the precharging step.

Such a feature makes it possible to avoid damage to individual capacitive components due to non-uniform voltages in the energy storage assembly.

Such a balancing circuit is for example activated at the start of the balancing step and deactivated after this balancing step in order to enable the rapid charge step.

The threshold voltage may be modified during implementation of the method.

Such a feature allows modifying the partial charging voltages according to the different requirements associated with the different flight phases.

The length of time separating the step of charging the capacitive components and the step of converting the stored electrical energy may be less than or equal to 10 minutes.

Such a feature allows limiting how long the capacitive components are kept at the high charging voltage, and thus allows reducing their aging.

### BRIEF DESCRIPTION OF THE FIGURES

FIG. 1 is a schematic representation of a twin-spool turbine engine according to the state of the art,

FIG. 2 is a schematic representation of a turbine engine for implementing a method according to the invention,

FIG. 3 is an electrical diagram of an energy storage assembly of the turbine engine of FIG. 2,

FIG. 4 is a partial electrical diagram of a balancing circuit of the turbine engine of FIG. 2,

FIGS. 5 to 8 schematically represent a method for controlling the turbine engine of FIG. 2,

FIGS. 9 and 10 schematically represent a method for controlling a hybrid turbine engine according to a second embodiment of the invention,

FIGS. 11 and 12 schematically represent a method for controlling a hybrid turbine engine according to a third embodiment of the invention.

### DETAILED DESCRIPTION OF THE INVENTION

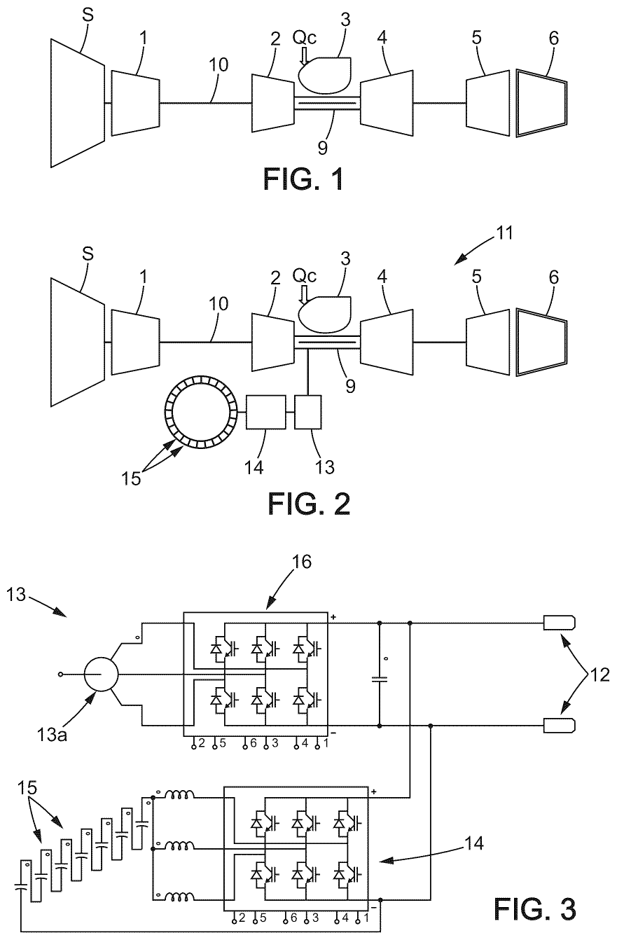

FIG. 2 shows a turbine engine 11 enabling the implementation of a method according to the invention, installed on an aircraft. Turbine engine 11, similarly to the one in FIG. 1, comprises from upstream to downstream in the direction of the gas flow: a fan S, a low-pressure compressor 1, a high-pressure compressor 2, a combustion chamber 3 which receives a flow of fuel Qc, a high-pressure turbine 4, a low-pressure turbine 5, and a primary exhaust nozzle 6.

Low-pressure compressor 1 and low-pressure turbine 5 are connected by a low-pressure shaft 10, and together form a low-pressure body.

High-pressure compressor 2 and high-pressure turbine 4 are connected by a high-pressure shaft 9, and together with combustion chamber 3 form a high-pressure body.

Fan S, which is driven by low pressure shaft 10, either directly or via a reduction gearbox, compresses the air coming from the air inlet. This air is divided downstream of fan S into a secondary air flow which is guided directly towards a secondary nozzle (not shown) through which it is ejected to contribute to the thrust provided by the turbine engine, and a so-called primary flow which enters the gas generator consisting of the low and high-pressure bodies, then is ejected into primary nozzle 6.

Turbine engine 11 also comprises a power conversion device 13 joined to high pressure shaft 9. Power conversion device 13 is capable of converting electrical power into mechanical power contributing to the rotation of high pressure shaft 9.

Power conversion device 13 is in particular capable of alternately operating as an electric motor 30 and as a generator, depending on the flight phases of the aircraft, and of taking mechanical power from high pressure shaft 9 to convert it into electrical power.

Power conversion device 13 is for example connected to the high-pressure shaft by an accessory gearbox (not shown) which engages with high-pressure shaft 9.

Turbine engine 11 also comprises an electrical energy storage assembly, said assembly comprising a power converter 14 and a plurality of capacitive components 15.

Capacitive components 15 are in particular supercapacitors, for example carbon nanotube supercapacitors.

A typical order of magnitude of startup assistance for a turbine engine is to supply power on the order of 500 KW for a duration of about 1 s, the total energy supplied therefore being on the order of 500 kJ. In this case, the capacity design of the supercapacitor-based storage assembly is defined both by the power density of the capacitive components and by the energy density that they store.

In this respect, supercapacitors made with carbon nanotubes and graphene make it possible to increase the electrical conductivity and thus to divide the resistivity of the components by 10 (or more), which allows the storage system to be adapted to operating cycles of around a second (instead of 10 to 20 seconds for conventional supercapacitors).

The storage assembly comprises for example 296 carbon nanotube supercapacitors of 900 F capacitance, connected in series, which makes it possible to obtain an equivalent series resistance (ESR) of less than 100 μOhms per component.

Such a number of supercapacitors having such a capacitance allows the energy storage assembly to store and restore sufficient electrical power for the needs mentioned above.

However, keeping these supercapacitors at a charge level close to their maximum charge for a prolonged period is likely to damage said capacitors over time, reducing the length of time that the energy storage assembly will operate properly.

The energy storage assembly is schematically represented in FIG. 3, which shows the electrical architecture of said assembly. Conversion device 13 conventionally comprises an electric machine 13a and an inverter 16, the latter being connected in parallel to power converter 14, here a chopper type of DC/DC converter.

Inverter 16 and converter 14 are configured to control the power taken from or fed to high-pressure shaft 9 or delivered to loads 12.

The energy storage assembly is for example also connected in parallel to loads 12 of the aircraft and may be used to supply them with electrical energy.

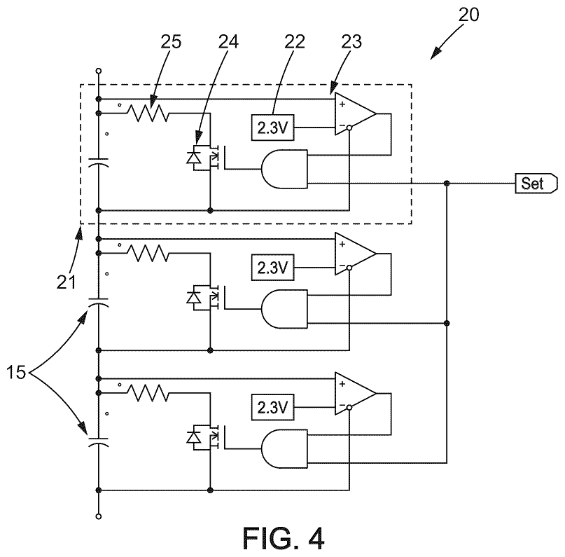

The energy storage assembly further comprises a balancing circuit 20, shown in part in FIG. 4, configured for balancing the voltages across capacitive components 15 by dissipating the excess stored energy, each capacitive component 15 thus having a voltage at its terminals substantially equal to a mean voltage which depends on the total energy stored by the system after dissipation of the excess.

Alternatively, balancing circuit 20 may be configured to transfer energy between capacitive components 15 in order to balance the voltages across them.

Indeed, after a first phase of precharging the capacitive components, the electrical charges of the various capacitive components may vary from one component to another, in particular due to variations in the individual capacitances of the components or due to spontaneous partial discharges.

However, wear and premature aging of the capacitive components is directly linked to the voltage at their terminals, and generally leads to a reduction in the component's capacitance. Since reduced capacitance leads to a higher voltage at the terminals of the component at an equal load, it is understood that any overvoltage has effects that tend to be amplified and lead to accelerated degradation of the component.

The use of balancing circuit 20 thus allows preserving capacitive components 15 by imposing a uniform voltage across the various capacitive components 15.

Balancing circuit 20 and the storage assembly define a plurality of cells 21 each comprising a capacitive component 15. Each cell 21 is self-powered and measures the voltage at the terminals of capacitive component 15.

Balancing circuit 20 comprises an isolated control voltage terminal Set, which allows activating the control of balancing circuit 20 and centrally manages the entire balancing circuit 20.

Activation of this control triggers a balancing cycle, described below.

If the voltage measured across capacitive component 15 is greater than a threshold 22 (2.3 V in this example), a comparator 23 switches a switching transistor 24 and capacitive component 15 discharges into resistor 25, with a time constant RC of several minutes. As soon as the voltage across capacitive component 15 is less than or equal to threshold 22, transistor 24 is no longer conductive and capacitive component 15 stops discharging.

The value of threshold 22 is for example set to be equal to a so-called intermediate charge value, at which capacitive components 15 do not suffer damage or excessive aging.

Advantageously, the value of threshold 22 may be modified dynamically during the different flight phases of the aircraft.

Thus, at the end of each balancing cycle, all capacitive components 15 having an initial voltage greater than that of threshold 22 are discharged down to said threshold. It is then sufficient to deactivate the control Set so that balancing circuit 20 is no longer used, in operating phases where the capacitive components are loaded to a value higher than the threshold value.

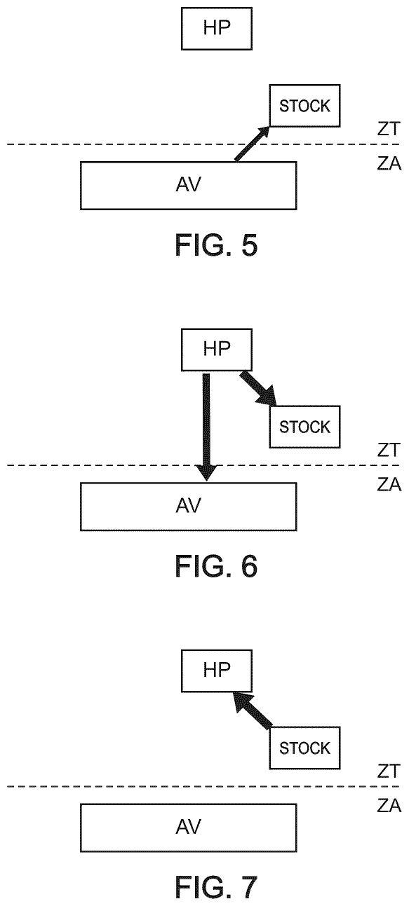

A method for implementing the energy storage assembly described above during the flight of an aircraft on which said storage assembly is installed is described below, with reference to FIGS. 5 to 8.

In FIGS. 5 to 8, the flows of electrical energy are schematically represented by arrows, between schematically represented high-pressure body HP and storage assembly STORE, in a turbine engine zone ZT, as well as the rest of the aircraft AC comprising the loads and energy sources onboard, represented in an aircraft zone ZA.

This method allows optimizing the operation of capacitive components 15, by using the maximum amount of stored energy without degrading their service life.

The method comprises a first step of precharging capacitive components 15, shown in FIG. 5, during which electrical power is supplied to capacitive components 15 to bring the mean voltage across said capacitive components to a so-called first partial charge value.

The mean voltage across capacitive components 15 at the end of the precharging step is for example between 75% and 85% of a maximum charge voltage of said components.

For example, for supercapacitors having a maximum charge voltage substantially equal to 2.85 V, the first partial charge voltage is substantially equal to 2.35 V.

The first partial charge voltage is chosen so that capacitive components 15 undergo reduced wear when the voltage at their terminals is maintained at the first partial charge voltage relative to the maximum charge voltage.

The precharging step is for example implemented when the aircraft is parked. It may last several minutes, which makes it possible to use a reduced charging current.

The energy required for precharging the capacitive components is for example from a source located in the aircraft zone, for example an auxiliary power source (or APU, for auxiliary power unit) or a ground source external to the aircraft. Indeed, at this stage of the flight the turbine engine cannot yet operate as a generator.

The method then comprises a step of balancing the voltages across each of capacitive components 15, implementing the balancing system described above.

The voltages across the various capacitive components 15 are balanced, such that each of the capacitive components has a voltage across its terminals that is substantially equal to the predetermined threshold value 22, i.e. substantially equal to the first partial charge voltage.

This step is for example implemented when the aircraft is moving on the ground from its parking point to a takeoff location, and may last several minutes.

The method then comprises a step of rapidly charging the capacitive components 15, shown in FIG. 6, until the mean voltage across the capacitive components reaches a high value.

The energy used for charging the capacitive components is drawn from the operating engines, via power conversion devices 13.

Said high value is for example between 95% and 100% of a maximum charging voltage of the capacitive components.

The high voltage is for example approximately equal to 2.85 V on average for each supercapacitor, for a total voltage of 843 V. A current of about 10 A makes it possible to rise from the partial charge value to the maximum charge value in approximately one minute.

The step of rapidly charging the capacitive components is for example implemented after the engines have been started, during the few minutes necessary for pre-takeoff checks. The balancing circuit is deactivated beforehand in order to allow charging the capacitive components.

Having the capacitive components 15 at maximum charge just before takeoff makes it possible to benefit from maximum assistance in takeoff without keeping these components at a maximum charge level for an extended period.

During the rapid charging step, the aircraft engines are on and operating as generators. They are therefore what provide the energy for charging capacitive components 15 to their maximum charge, via power conversion device 13.

The method then comprises a step of converting the electrical energy stored in the storage assembly into mechanical energy delivered to the high-pressure shaft in order to assist with the aircraft takeoff, as shown in FIG. 7.

The stored energy is supplied for a duration of about 1.5 s, which makes it possible to concentrate this assistance to the critical moment requiring the most acceleration.

This conversion results in a partial or total discharge of capacitive components 15.

Advantageously, the time separating the rapid charging of the capacitive components until the high voltage is reached, and the discharging by conversion of the stored electrical energy into mechanical energy for assisting with takeoff, is less than or equal to 10 minutes and preferably less than or equal to 5 minutes.

The method may comprise a subsequent step of recharging the capacitive components by using the turbine engine as an electric generator and by drawing power from high-pressure shaft 9 via conversion device 13, identical to what is represented in FIG. 6.

Capacitive components 15 are recharged until the mean voltage across said capacitive components is substantially equal to a second partial charge value.

The second partial charge value may be equal to the first partial charge value or slightly different, while remaining within the same voltage range and having the features and advantages described above.

For example, for supercapacitors having a maximum voltage substantially equal to 2.85 V, the second partial charge voltage is substantially equal to 2.2 V, which avoids wearing out the supercapacitors.

The total voltage across the energy storage assembly is then, for example, substantially equal to 650 V.

Once the capacitors are charged, recharging is stopped and the energy drawn from the high-pressure shaft is used only to power the aircraft loads. In the event of load shedding, if consumption by the loads temporarily becomes too low compared to the power being drawn, the excess power is temporarily stored in the storage system so as to limit overvoltages while the power being drawn is adjusted.

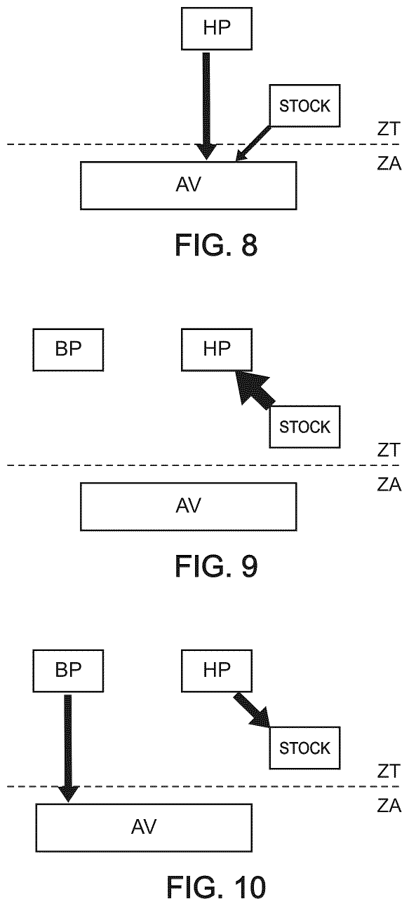

Advantageously, during flight, the energy storage assembly is used to improve the quality of the aircraft's electrical system by supplementing the energy drawn in the standard manner from high-pressure shaft 9, as shown in FIG. 8.

The energy stored in the energy storage assembly is used to power loads 12 of the aircraft on an ad-hoc basis, to compensate for a temporary fault in the main power supply and/or isolated incidents of too-high demand. Recharging of the capacitive components is temporarily stopped when providing this additional energy.

This step may be implemented in alternation with the recharging of capacitive components 15, shown in FIG. 6, as such providing of additional energy is infrequent and on an ad-hoc basis. Indeed, the storage assembly and power converter 14 are sized to provide very high power (500 KW in the example described) for a duration of about one second. They can therefore easily assist the generator as well as assist with its regulation in the event of transient high current draw, short circuit in the network, or load shedding, and thus avoid voltage dips and overvoltages on the aircraft's electrical network.

The method may then comprise a step of charging the capacitive components to the maximum, implemented during the aircraft's descent, during which the voltage across the capacitive components is raised to a mean voltage substantially equal to the maximum charging voltage. This charge is kept available at the end of the aircraft's descent, during the landing phase, to assist with a possible emergency maneuver such as an emergency takeoff (touch-and-go, go-around, etc.).

After landing, the method comprises a step of discharging capacitive components 15 in order to protect these components. The stored energy may advantageously be used during the phase when the aircraft travels on the ground to its parking location, in order to save energy from other sources.

According to a variant (not shown), conversion device 13 is configured to operate with an alternating current (AC) distributed to loads 12 of the aircraft. Conversion device 13 is then for example a three-phase generator.

Converter 14 is then replaced by an AC/DC converter at the input to the electrical energy storage assembly, which allows regulating the input voltage to the DC network composed of the storage assembly. Said converter 14 comprises for example an LC or LCL type filter.

According to another embodiment, shown in FIGS. 9 and 10, turbine engine 11 comprises a first conversion device 13 associated with high-pressure shaft 9, in high-pressure body HP, and a second conversion device associated with low-pressure shaft 10, in low-pressure body LP, both connected to energy storage assembly STORE, in turbine engine zone ZT.

Such an arrangement offers additional options for the method for controlling the turbine engine 11 and the energy storage assembly.

In such a configuration, first conversion device 13 is typically not designed to supply power to loads 12, but only to charge the energy storage assembly and assist with acceleration. This design, which is limited to ad-hoc use, allows reducing the mass of the device.

The precharging step, the voltage balancing step, and the step of charging capacitive components 15 to a maximum voltage are substantially unchanged in this embodiment. The energy storage assembly is charged by an external source, as the turbine engine is unable to operate as an energy generator before takeoff.

Takeoff assistance is also unchanged, with the stored electrical power converted into mechanical power supplied to high-pressure body HP by first conversion device 13, as shown in FIG. 9.

During the flight, as shown in FIG. 10, the power supply to loads 12 of the aircraft is ensured by low-pressure body LP, while the recharging of storage assembly STORE is assigned to high-pressure body HP.

Thus, when turbine engine 11 is operating as an electric generator, first conversion device 13 charges capacitive components 15 and keeps them at the desired charge level, as explained above, while the second conversion device supplies power to loads 12.

When acceleration assistance is required, the energy stored in the storage assembly is returned to high-pressure shaft 9 by first conversion device 13, while the second conversion device continues to supply power to loads 12, without impacting the stresses on high-pressure shaft 9 and without slowing.

At the end of this assistance, body HP resumes its role of recharging storage assembly STORE until landing and of performing the final discharge of the capacitive components.

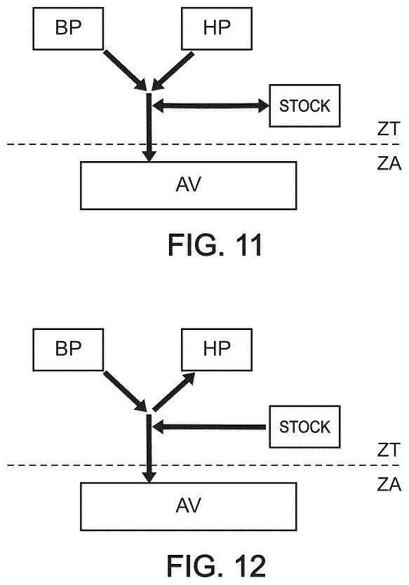

In another embodiment, shown in FIGS. 11 and 12, which covers the case of a fully DC-type network, the two power conversion devices may be arranged in parallel electrically, the high-pressure HP and low-pressure LP bodies powering the loads of aircraft AC and storage assembly STORE in parallel.

The precharging, balancing, maximum charge, and takeoff assistance steps remain substantially unchanged compared to was described in the previous embodiment.

After takeoff, when the turbine engine is able to operate in generator mode, the high-pressure HP and low-pressure LP assemblies power the loads of aircraft AC in parallel, as shown in FIG. 11. In addition, depending on requirements, storage assembly STORE is recharged in parallel by the high-pressure HP and low-pressure LP assemblies, or else supplies power on an ad-hoc basis to the loads of aircraft AC in order to stabilize the network.

In case there is a need for propulsion assistance, as shown in FIG. 12, low-pressure assembly LP continues to power the loads of aircraft AC, with additional power supplied from the energy storage assembly if necessary. Assembly HP benefits from the remainder of the energy stored in the storage assembly, as described above.

The role of network stabilization is therefore maintained in this embodiment for energy storage assembly STORE, and an overloading of low-pressure assembly LP with an associated slowdown are avoided due to this additional supply of power, when assembly HP switches to electric assistance mode.

1. A method for controlling a hybrid turbine engine (11) for an aircraft, the turbine engine (11) comprising a low-pressure body having a low-pressure shaft (10) and a high-pressure body having a high-pressure shaft (9), the turbine engine (11) also comprising at least one power conversion device (13) mounted on the low-pressure shaft (10) or high-pressure shaft (9) and an energy storage assembly connected to the power conversion device (13), the energy storage assembly comprising a plurality of capacitive components (15),
the method comprising steps of:
precharging the capacitive components (15) until a mean voltage across the capacitive components (15) reaches a first partial charge value,
balancing the voltages across each of the capacitive components (15),
rapidly charging the capacitive components (15) until the mean voltage across the capacitive components (15) reaches a high value, and
converting electrical energy stored in the storage assembly into mechanical energy delivered to the low-pressure shaft (10) and/or to the high-pressure shaft (9) in order to assist with a maneuver of the aircraft.

2. The method according to claim 1, wherein the maneuver of the aircraft is a takeoff.

3. The method according to claim 1, comprising a step of using the electrical energy stored in the capacitive components (15) to improve a service quality of an electrical network of the aircraft during flight.

4. The method according to claim 1, wherein the power conversion device (13) is mounted on the high-pressure shaft (9) and is arranged to transfer power only between the high-pressure shaft (9) and the energy storage assembly, the turbine engine (11) also comprising a second power conversion device mounted on the low-pressure shaft (10) and arranged to draw power from the low-pressure shaft (10) so as to power loads (12) of the aircraft during flight.

5. The method according to claim 1, further comprising steps of:
recharging the capacitive components (15) until the mean voltage across the capacitive components (15) reaches a second partial charge value,
charging the capacitive components (15) until the mean voltage across the capacitive components reaches the high value, and
making available the electrical energy stored in the capacitive components (15), during a second maneuver of the aircraft, in order to assist with a possible auxiliary maneuver, and
if the auxiliary maneuver was not implemented, discharging the capacitive components (15).

6. The method according to claim 5, wherein the second maneuver of the aircraft is a landing and the auxiliary maneuver is an emergency takeoff.

7. The method according to claim 1, wherein the energy storage assembly is configured to deliver a power greater than or equal to 500 kW for a duration of between 0.5 seconds and 2 seconds.

8. The method according to claim 1, wherein the balancing step is implemented by means of a balancing circuit (20) configured to lower the voltage across each capacitive component (15) to a threshold voltage (22) after the precharging step.

9. The method according to claim 8, wherein the threshold voltage (22) may be modified during implementation of the method.

10. The method according to claim 1, wherein the length of time separating the step of rapidly charging the capacitive components (15) and the step of converting the stored electrical energy is less than or equal to 10 minutes.
